(19) United States
(12) Patent Application Publication
(10) Pub. No.: US 2026/0357491 A1
(43) Pub. Date: Nov. 12, 2026

(54) MODIFIED UREA-FORMALDEHYDE BINDERS FOR NON-WOVEN FIBER GLASS MATS

(71) Applicant: JOHNS MANVILLE, Denver, CO (US)

(72) Inventors: Guodong Zheng, Highlands Ranch, CO (US); Luke S. Weith, Littleton, CO (US); Mingfu Zhang, Highlands Ranch, CO (US); Jawed Asrar, Englewood, CO (US)

(21) Appl. No.: 19/200,955

(22) Filed: May 7, 2025

(51) Int. Cl. D04H 1/587; C08G 4/00; C08L 61/00; D04H 1/4218; D04H 1/72

(52) U.S. Cl. CPC D04H 1/587; C08G 4/00; C08L 61/00; D04H 1/4218; D04H 1/72; D10B 2401/063

(57) ABSTRACT

A binder composition includes a modified urea-formaldehyde resin composed of a urea-formaldehyde resin, one or more starch compounds combined with the urea-formaldehyde resin, and a hydrophobic agent combined with the urea-formaldehyde resin and one or more starch compounds to form the modified urea-formaldehyde resin. The one or more starch compounds are combined with the urea-formaldehyde resin so that the modified urea-formaldehyde resin includes about 0.5 wt. % to about 10 wt. % of the one or more starch compounds and the hydrophobic agent is combined with the urea-formaldehyde resin and one or more starch compounds so that the modified urea-formaldehyde resin includes about 0.5 wt. % to about 5 wt. % of the hydrophobic agent.

### BACKGROUND OF THE INVENTION

Thermoset urea-formaldehyde (UF) resins are commonly used as binders for non-woven glass mats because of their suitability for various applications and their relatively low cost. However, non-woven glass mats bonded with UF resins are often brittle and cause processing and product performance issues. In order to overcome these issues, it is common to modify UF resin with conventional latexes, such as polyvinyl acetate, polyethylene vinyl acetate, polyacrylate, acrylic, vinyl acrylic, or styrene-butadiene latexes. Modifying UF resin with conventional latexes improves the flexibility of non-woven glass mats which in turn improves the strength of non-woven glass mats. Improved strength is needed to achieve high speed processing of non-woven glass mats on commercial manufacturing lines as well as optimal product performance. However, these conventional latex modifiers are typically expensive and the modification of UF resins with conventional latexes increases binder cost significantly. In addition, conventional latexes are petroleum-based and are thus derived from a non-renewable and non-sustainable resource.

### BRIEF SUMMARY OF THE INVENTION

Binder compositions are described that include urea-formaldehyde (UF) resin, a hydrophobic agent, and one or more starch compounds or latex modifiers. According to one embodiment, a binder composition includes a modified urea-formaldehyde resin that includes a urea-formaldehyde resin, one or more starch compounds combined with the urea-formaldehyde resin, and a hydrophobic agent that is combined with the urea-formaldehyde resin and one or more starch compounds to form the modified urea-formaldehyde resin. The one or more starch compounds are combined with the urea-formaldehyde resin so that the modified urea-formaldehyde resin includes about 0.5 wt. % to about 10 wt. % of the one or more starch compounds, more commonly about 0.5 wt. % to about 5 wt. % of the one or more starch compounds, or about 1 wt. % to about 2 wt. % of the one or more starch compounds. The hydrophobic agent is combined with the urea-formaldehyde resin and one or more starch compounds so that the modified urea-formaldehyde resin includes about 0.5 wt. % to about 5 wt. % of the hydrophobic agent, and more commonly about 0.5 wt. % to about 3 wt. % of the hydrophobic agent. The hydrophobic agent may include a polymer and a hydrophobic group.

According to another embodiment, a binder composition includes a modified urea-formaldehyde resin that includes a urea-formaldehyde resin, one or more latex modifiers combined with the urea-formaldehyde resin, and a hydrophobic agent that is combined with the urea-formaldehyde resin and one or more latex modifiers to form the modified urea-formaldehyde resin. The one or more latex modifiers are combined with the urea-formaldehyde resin so that the modified urea-formaldehyde resin includes about 0.5 wt. % to about 10 wt. % of the one or more latex modifiers, and more commonly about 1 wt. % to about 5 wt. % of the one or more latex modifiers. The hydrophobic agent is combined with the urea-formaldehyde resin and one or more latex modifiers so that the modified urea-formaldehyde resin includes about 0.5 wt. % to about 5 wt. % of the hydrophobic agent, and more commonly about 0.5 wt. % to about 3 wt. % of the hydrophobic agent. The hydrophobic agent may include a polymer and a hydrophobic group. The one or more latex modifiers may be polyvinyl acetate, polyethylene vinyl acetate, polyacrylate, acrylic, vinyl acrylic, styrene-butadiene latexes, or a combination thereof.

According to another embodiment, a method of forming a binder composition includes providing a urea-formaldehyde resin and combining one or more starch compounds or latex modifiers with the urea-formaldehyde resin. The method also includes combining a hydrophobic agent with the urea-formaldehyde resin and one or more starch compounds or latex modifiers to form a modified urea-formaldehyde resin. The one or more starch compounds or latex modifiers are combined with the urea-formaldehyde resin so that the modified urea-formaldehyde resin includes about 0.5 wt. % to about 10 wt. % of the one or more starch compounds or latex modifiers, more commonly about 0.5 wt. % to about 5 wt. % of the one or more starch compounds or latex modifiers, or about 1 wt. % to about 2 wt. % of the one or more starch compounds or latex modifiers. The hydrophobic agent is combined with the urea-formaldehyde resin and one or more starch compounds or latex modifiers so that the modified urea-formaldehyde resin includes about 0.5 wt. % to about 5 wt. % of the hydrophobic agent, and more commonly about 0.5 wt. % to about 3 wt. % of the hydrophobic agent. The hydrophobic agent may include a polymer and a hydrophobic group.

According to another embodiment, a non-woven fiber mat includes a plurality of fibers that form a fiber mesh and a modified urea-formaldehyde resin that is applied to the fiber mesh to bond the plurality of fibers together. The modified urea-formaldehyde resin includes a urea-formaldehyde resin, one or more starch compounds or latex modifiers combined with the urea-formaldehyde resin, and a hydrophobic agent. The modified urea-formaldehyde resin includes about 0.5 wt. % to about 10 wt. % of the one or more starch compounds or latex modifiers, and more commonly about 0.5 wt. % to about 5 wt. % of the one or more starch compounds or latex modifiers. The modified urea-formaldehyde resin also includes about 0.5 wt. % to about 5 wt. % of the hydrophobic agent, and more commonly about 0.5 wt. % to about 3 wt. % of the hydrophobic agent.

The fibers of the fiber mesh may consist of glass fibers. The fibers may have an average fiber diameter of between 15 to 20 microns and/or an average fiber length of between 0.5 and 2.0 inches. The non-woven fiber mat may have a basis weight of between 49 g/m² and 98 g/m². The hydrophobic agent may include a polymer and a hydrophobic group.

According to another embodiment, a method of forming a non-woven fiber mat includes providing a binder composition that includes a urea-formaldehyde resin, about 0.5 wt. % to about 10 wt. % of a starch or latex modifier, and about 0.5 wt. % to 5 wt. % of a hydrophobic agent. The method also includes applying the binder composition to a wet laid fiber mesh, drying the wet laid fiber mesh, and curing the binder composition to bond fibers of the fiber mesh and thereby form the non-woven fiber mat. In some embodiments, the modified urea-formaldehyde resin may include about 0.5 wt. % to about 3 wt. % of the hydrophobic agent and/or about 0.5 wt. % to about 5 wt. % of the starch or latex modifier.

According to another embodiment, a composite asphalt roofing shingle includes a non-woven fiber mat including a plurality of fibers that form a fiber mesh and a modified urea-formaldehyde resin that is applied to the fiber mesh to bond the plurality of fibers together. The modified urea-formaldehyde resin includes a urea-formaldehyde resin, one or more starch compounds or latex modifiers combined with the urea-formaldehyde resin, and a hydrophobic agent. Asphalt is applied to at least one side of the non-woven fiber mat so that the non-woven fiber mat is saturated with the asphalt and granules are positioned on an upper or exterior surface of the composite asphalt roofing shingle and pressed into the asphalt. The modified urea-formaldehyde resin includes about 0.5 wt. % to about 10 wt. % of the one or more starch compounds or latex modifiers and about 0.5 wt. % to about 5 wt. % of the hydrophobic agent. In some instances, the modified urea-formaldehyde resin includes about 0.5 wt. % to about 3 wt. % of the hydrophobic agent and/or about 0.5 wt. % to about 5 wt. % of the one or more starch compounds or latex modifiers. The hydrophobic agent may include a polymer and a hydrophobic group.

In some instances, the asphalt is an oxidized asphalt or a modified asphalt. The fibers of the fiber mesh may consist of glass fibers. The fibers may have an average fiber diameter of between 15 to 20 microns and/or an average fiber length of between 0.5 and 2.0 inches. The non-woven fiber mat may have a basis weight of between 49 g/m² and 98 g/m².

According to another embodiment, a method of forming a roofing shingle includes providing a non-woven fiber mat that includes a plurality of fibers that form a fiber mesh and a modified urea-formaldehyde resin that is applied to the fiber mesh to bond the plurality of fibers together. The modified urea-formaldehyde resin includes a urea-formaldehyde resin, about 1.0 wt. % to about 10 wt. % of a starch or latex modifier, and about 0.5 wt. % to 5 wt. % of a hydrophobic agent. The method also includes applying asphalt to at least one side of the non-woven fiber mat so that the non-woven fiber mat is saturated with the asphalt and pressing granules into the asphalt. The granules are positioned on an upper or exterior surface of the roofing shingle. In some instances, the modified urea-formaldehyde resin includes about 0.5 wt. % to about 3 wt. % of the hydrophobic agent and/or about 0.5 wt. % to about 5 wt. % of the starch or latex modifier. The hydrophobic agent may include a polymer and a hydrophobic group.

### BRIEF DESCRIPTION OF THE DRAWINGS

A further understanding of the nature and advantages of the present invention may be realized by reference to the remaining portions of the specification and the drawings wherein like reference numerals may be used throughout the drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 illustrates a method of forming a binder composition.

FIG. 2 illustrates a non-woven fiber mat.

FIG. 2A illustrates a plurality of fibers that are randomly oriented to form a fiber mesh of the non-woven fiber mat of FIG. 2.

FIG. 3 illustrates a non-woven fiber mat that is composed of glass fibers with an average length of about 1.25 inches and an average diameter of 16 μm.

FIG. 4 illustrates a non-woven fiber mat that is composed of glass fibers with an average length of about 1.50 inches and an average diameter of 18 μm.

FIG. 5 illustrates air permeability of the non-woven glass mat of FIG. 3 and the non-woven glass mat of FIG. 4.

FIG. 6 illustrates percentages of total tear strength of non-woven glass mats made with modified UF binders in comparison with a control sample mat made with a non-modified UF binder.

FIG. 7 illustrates percentages of total tear strength of non-woven glass mats made with RHOPLEX™ GL-720 latex modified UF binders with and without the hydrophobic agent Rheovis® HS 1332.

FIG. 8 illustrates a composite asphalt roofing shingle.

FIG. 9 illustrates a method of forming a non-woven fiber mat.

FIG. 10 illustrates a method of forming a composite asphalt roofing shingle.

### DETAILED DESCRIPTION OF THE INVENTION

Exemplary binder compositions and their use in non-woven fiber mats are described. These compositions include a combination of a thermoset binder, such as urea-formaldehyde (UF) and a hydrophobic agent, such as hydrophobically modified alkali-swellable emulsion (HASE) polymers. In some embodiments, the UF resin and hydrophobic agent also include one or more starches, while in other embodiments, the UF resin and hydrophobic agent also include a latex modifier, such as a conventional acrylic latex. The non-woven fiber mats made from these binder compositions may exhibit substantial improvements in strength characteristics, such as tear strength, in comparison with conventional non-woven fiber mats made with non-modified UF binders or UF binders containing conventional latex modifiers.

### Exemplary Binder Compositions

The present binder compositions may include a urea-formaldehyde based resin, one or more starch compounds or latex modifiers, and a hydrophobic rheology agent or hydrophobic agent. The hydrophobic agent typically comprises a polymer with one or more hydrophobic groups. In some instances, the one or more starch compounds may be used in concentrations that promote the toughening and/or strengthening of a non-woven mat made from the binder. The urea-formaldehyde based resin, one or more starch compounds or latex modifiers, and a hydrophobic agent are combined to form a modified urea-formaldehyde resin (hereinafter binder composition). The combination of the urea-formaldehyde based resin, one or more starch compounds or latex modifiers, and hydrophobic agent provides a synergic effect that greatly improves one or more characteristics of a non-woven mat formed therefrom. For example, a non-woven mat formed from the binder composition exhibits a substantial improvement in tear strength, which is critical in certain applications, such as asphalt shingles. Non-woven fibrous mats produced using the binder composition described herein provide equivalent or better performance as control sample made with non-modified UF or UF modified with conventional latex even at a lower basis weight of the non-woven mat. For ease in describing the various embodiments, the binder composition will be generally described as including urea-formaldehyde based resin, one or more starch compounds, and a hydrophobic agent. It should be realized, however, that one or more latex modifiers, such as conventional acrylic latex, could be substituted for the one or more starch compounds, or used in combination with the one or more starch compounds, in any of the embodiments described herein. Thus, unless specifically recited in the claims, it should be understood that the reference to “one or more starch compounds” as used herein could be substituted with “one or more latex modifiers” or “conventional acrylic latex” without departing from the scope of the disclosure.

Exemplary starch concentration ranges may be from about 0.5 wt. % to about 10 wt. % of the binder composition. Additional exemplary starch concentration ranges may include about 0.5 wt. % to about 7.5 wt. %; about 1 wt. % to about 5 wt. %; 1 wt. % to about 4 wt. %; about 1 wt. % to about 3 wt. %; about 1 wt. % to about 2.5 wt. %; about 1 wt. % to about 2 wt. %; about 1 wt. % to about 1.5 wt. %, etc.

A ceiling for the starch concentration may be set such that the starch does not function as a significant thickener in the binder composition that substantially increases the viscosity of the composition. For example, the concentration of the starch may have an upper limit threshold of about 10 wt. % in embodiments where it is not desired for the starch to act as a thickener.

The starches used in the present binder compositions may include one or more native or modified starches. The native or modified starches may be derived from corn, potatoes, tapioca, or wheat among other sources. Exemplary modified starches may include cationic or anionic starches. Examples of modified cationic starch include RediBOND 5330 starch or CATO® 232 starch from Ingredion.

In some embodiments, the molecular size of the starch compounds may be controlled to affect the performance of the binder compositions. Exemplary weight average molecular weights of starch compounds may include a range of about 200,000 g/mol or less; about 190,000 g/mol or less; about 180,000 g/mol or less; about 170,000 g/mol or less; about 160,000 g/mol or less; or about 150,000 g/mol or less; etc. Further exemplary weight average molecular weights may include about 100,000 g/mol or less; about 90,000 g/mol or less; about 80,000 g/mol or less; about 70,000 g/mol or less; about 60,000 g/mol or less; about 50,000 g/mol or less; etc.

Higher weight average molecular weight ranges for the starches are also contemplated for embodiments of the present binder compositions. For example, the starch may have a weight average molecular weight range of about 100,000 to about 2,000,000 g/mole. Additional exemplary ranges include about 200,000 to about 1,000,000 g/mole.

The thermosetting urea-formaldehyde (UF) resins used in the present binder compositions may be prepared from urea and formaldehyde monomers and UF precondensates. Suitable resin compositions include thermosetting UF resin compositions that can be used for making binder compositions for fiber mats. Any form of these resin compositions which can react with other reactants and not introduce extraneous moieties deleterious to the desired reaction and reaction product can be utilized. Exemplary thermosetting UF resins that may be used in preparing the present binder compositions are disclosed in U.S. Pat. No. 5,851,933, the disclosure of which is incorporated herein by reference for all purposes.

Formaldehyde for making the thermosetting UF resin is available in many forms. Examples include paraform (solid, polymerized formaldehyde) and formalin solutions (aqueous solutions of formaldehyde, sometimes with a small amount of methanol, in 37%, 44%, or 50% formaldehyde concentrations). Formaldehyde also is available as a gas.

Similarly, urea for thermosetting UF resins is available in many forms. Solid urea, such as prill, and urea solutions, typically aqueous solutions, may be used. Further, the urea may be combined with another moiety, such as formaldehyde and urea-formaldehyde adducts, which may be provided in aqueous solution.

A wide variety of procedures may be used for reacting the principal urea and formaldehyde components to form an aqueous thermosetting UF resin composition, such as staged monomer addition, staged catalyst addition, pH control, and amine modification among other procedures. The urea and formaldehyde may be reacted at a mole ratio of formaldehyde to urea (F:U) in the range of about 1.1:1 to 4:1. For example, urea and formaldehyde may be reacted at an F:U mole ratio of between about 2.1:1 to 3.2:1. The UF resin may also be highly water dilutable, if not water soluble.

Exemplary resin compositions may contain reactive methylol groups, which upon curing form methylene or ether linkages. Such methylol-containing adducts may include N,N′-dimethylol, dihydroxymethylolethylene; N,N′bis(methoxymethyl), N,N′-dimethylolpropylene; 5,5-dimethyl-N, N′dimethylolethylene; N,N′-dimethylolethylene; and the like.

Thermosetting UF resins useful in the practice of the invention may contain 45 to 75% by weight nonvolitiles, for example about 50 to 60% by weight nonvolitiles. These resins may also have an initial viscosity of about 50 to 600 cPs. For example, a thermosetting UF resin useful in the practice of the invention may have a viscosity of 150 to 400 cPs. Additionally, a thermosetting UF resin may exhibit a pH of 7.0 to 9.0 or alternatively 7.5 to 8.5. These resins may also have a free formaldehyde level of not more than about 3.0% (for example less than 1.0%) and a water dilutability of 1:1 to 100:1 (for example 5:1 and above).

A resin modifier such as ammonia, alkanolamines, or polyamines may be added to the reactants that are used to make the UF resin. Polyamines may include an alkyl primary diamine such as ethylenediamine (EDA). Additional modifiers, such as melamine, ethylene ureas, primary amines, secondary amines, and tertiary amines may also be incorporated into a UF resin. Concentrations of these modifiers in the reaction mixture often will vary from 0.05 to 15.0% by weight of the UF resin solids. These types of modifiers may promote hydrolysis resistance, polymer flexibility, and lower formaldehyde emissions in the cured resin. Further urea additions for purposes of scavenging formaldehyde or as a diluent may also be used. The present binder compositions may also contain a variety of additives such as colloidal silica to enhance fire resistance, antifoamers, biocides, pigments, surfactants and the like.

The binder compositions may have a solids content of about 5 wt. % to about 70 wt. %. Exemplary solids contents for binder compositions that have not been diluted with water (e.g., resin compositions) may be greater than about 35 wt. %; greater than about 40 wt. %; greater than about 45 wt. %; greater than about 50 wt. %; etc. Exemplary solids content ranges may include about 5 wt. % to about 35 wt. % and about 45 wt. % to about 70 wt. %, among others. Exemplary solids contents for aqueous binder compositions may include about 35 wt. % or less; about 30 wt. % or less; about 25 wt. % or less; about 20 wt. % or less; about 15 wt. % or less; etc. Exemplary solids content ranges for aqueous binder compositions may include about 10 wt. % to about 30 wt. %, among others. As previously described, in some instances the hydrophobic agent includes or

consists of a polymer containing one or more hydrophobic groups. For example, the hydrophobic agent may include hydrophobically modified alkali-swellable emulsion (HASE) polymers. HASE polymers are a type of rheology modifier that combines the thickening properties of alkali swellable emulsions (ASEs) with the associative properties of hydrophobic groups. HASE polymers are typically synthesized using emulsion polymerization techniques, involving monomers like methacrylic acid, ethyl acrylate, and associative monomers with hydrophobic groups.

HASE polymers offer a unique combination of thickening and shear-thinning behavior. HASE polymers achieve thickening through a dual mechanism: alkali swelling and hydrophobic association. Alkali swelling is due to HASE polymers containing carboxylic acid groups that, when neutralized by an alkali, cause the polymer to swell and become soluble in water, thereby increasing the solution's viscosity. Hydrophobic association is due to HASE polymers having hydrophobic groups that associate with each other and other components of the formulation, which further contributes to thickening. The hydrophobic groups in HASE polymers allow them to interact with binders and other components in the formulation, leading to a more stable and well-controlled rheology.

In solutions, HASE polymers form a transient network through molecular associations between the hydrophobic groups. Due to these hydrophobic interactions, HASE polymers are rheology modifiers that provide a unique combination of thickening and shear-thinning, which makes them suitable for a wide range of water-based applications, such as binders, coatings, inks, and other systems where viscosity control and flow properties are important.

Common examples of hydrophobic groups in HASE polymers include alkyl groups and/or aromatic groups. The alkyl groups are straight or branched chains of hydrocarbons, such as octyl, decyl, dodecyl or stearyl groups. The aromatic groups include benzyl or phenyl groups, which have a ring structure that contributes to hydrophobic interactions. The hydrophobic groups in HASE polymers are attached to the polymer backbone and interact with other hydrophobic components in binders, enhancing binder viscosity and stability. In a specific embodiment, the HASE polymer used in the binder composition described herein is a copolymer, or terpolymer, of acrylic (methacrylic) acid, nonionic monomer such as ethyl acrylate, and hydrophobic macromer with C8-C20 chain substitutes. The hydrophobic macromer is typically between 0.1 and 10.0 mol % in the polymer, between 0.5 and 5.0 mol % in the polymer, or between 1.0 and 3.0 mol % in the polymer.

Examples of HASE polymers that may be used in the binder composition include Rheovis® HS 1332 sold by BASF, Rheotech™ 2800 sold by Arkema S.A, RHOPLEX™ RM-232D sold by Dow Chemical Company, Novethix™ HC200 sold by Lubrizol Corporation, and/or Rheomer® 33T sold by Univar Solutions Inc.

### Exemplary Method of Forming Binder Composition

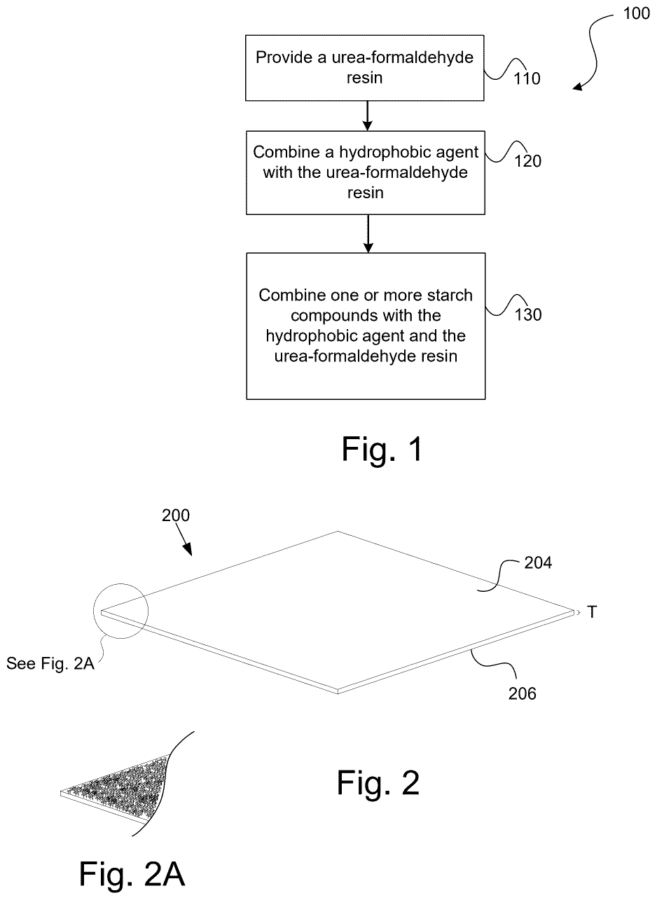

Referring to FIG. 1, illustrated is a method 100 of forming a binder composition. At block 110, a urea-formaldehyde resin is provided. The urea-formaldehyde resin may include a composition as described herein. At block 120, a hydrophobic agent is combined with the urea-formaldehyde resin. The hydrophobic agent may include a composition as described herein, such as the HASE polymers previously described. At block 130, one or more starch compounds are combined with the urea-formaldehyde resin and hydrophobic agent to form a modified urea-formaldehyde resin. The one or more starch compounds may have a composition as described herein.

In some instances, the hydrophobic agent is combined with the urea-formaldehyde resin and one or more starch compounds so that the modified urea-formaldehyde resin includes about 0.5 wt. % to about 5.0 wt. % of the hydrophobic agent, or may include about 0.5 wt. % to about 3.0 wt. % of the hydrophobic agent. The one or more starch compounds may be combined with the urea-formaldehyde resin and hydrophobic agent so that the modified urea-formaldehyde resin includes about 0.5 wt. % to about 10.0 wt. % of the one or more starch compounds, or may include about 0.5 wt. % to about 5.0 wt. % of the one or more starch compounds. The hydrophobic agent may include or consist of a polymer and a hydrophobic group.

Starch may be incorporated into urea formaldehyde via condensation polymerization of the aqueous solution of starch, formaldehyde, and urea, in which water in the starch slurry provides an aqueous environment for formaldehyde and urea. In other instances, the urea-formaldehyde resin may be synthesized from the aqueous solution of formaldehyde and urea and the starch slurry may be added to the aqueous solution of formaldehyde and urea during synthesis of the urea-formaldehyde resin to combine the one or more starch compounds with the urea-formaldehyde resin. In other instances, the urea-formaldehyde resin may be synthesized by heating the aqueous solution of formaldehyde and urea to at or near a boiling temperature of the aqueous solution of formaldehyde and urea and the starch slurry may be combined with the heated aqueous solution of formaldehyde and urea solution and cooled to an ambient temperature. The synthesized urea-formaldehyde resin may be composed mainly of low-molecular-weight intermediate polymers or prepolymers.

The binder composition may have a solids content of about 5 to 35 wt. % or may have a solids content of greater than 35 wt. %. The one or more starch compounds may be selected from the group consisting of a native starch, a cationically modified starch, and an anionically modified starch. Hydroxyl functional groups on the one or more starch compounds may bond to reactive functional groups on the urea-formaldehyde resin. The binder composition may include about 1 wt. % to about 2 wt. % of the one or more starch compounds.

### Exemplary Non-Woven Fiber Mats

Referring to FIG. 2, illustrated is a non-woven fiber mat or fiber reinforced composite 200 (hereinafter non-woven fiber mat 200) that includes a plurality of fibers that form a fiber mesh and a modified urea-formaldehyde resin as described herein applied to the fiber mesh to bond the plurality of fibers together. The non-woven fiber mat 200 includes a top surface 204 and a bottom surface 206 that is positioned opposite the top surface 204. The non-woven fiber mat 200 also typically includes four opposing sides so that the non-woven fiber mat 200 has a rectangular or square shape. The non-woven fiber mat may be wound into a roll product.

FIG. 2A illustrates an example of the plurality of fibers that are randomly oriented to form the fiber mesh. While the randomly oriented fibers that form the fiber mesh are illustrated in FIG. 2A, it should be realized that the composition of the entire non-woven fiber mat 200 would include the randomly oriented fibers.

The fibers may be organic and/or inorganic fibers. Organic fibers may include without limitation, acrylic, aromatic polyamides, polyesters, cellulosic fibers, and/or polyolefin fibers among others. Exemplary inorganic fibers may include mineral fibers, ceramic fibers, carbon fibers, graphite fibers, metal fibers, metal coated glass or graphite fibers, and/or glass fibers among others. Various glass fibers may be suitable for use in this invention including E type, T type, C type, A type, and S type glass fibers. In one embodiment, a non-woven fiber mat 200 may include a binder matrix made from the present binder composition and glass fibers. In another embodiment, a non-woven fiber mat 200 may include a binder matrix made from the present binder composition, glass fibers, and up to about 25 wt. % organic fibers. As described herein, the modified urea-formaldehyde resin (binder composition) includes a urea-formaldehyde resin, a hydrophobic agent that includes a polymer and hydrophobic groups, and one or more starch compounds combined with the urea-formaldehyde resin and hydrophobic agent.

Fibers used in the present non-woven fiber mats may independently have lengths of about 0.5 inches to about 2 inches (about 12.7 to about 50.8 mm) and diameters of about 10 to 20 microns. For example, glass fibers having diameters in the range of 15 to 20 microns may be used. Alternatively, glass fibers having diameters in the range of 15 to 18 microns may be used. More commonly, the fibers may have a length of between 1.0 and 2.0 includes, and even more commonly a length of between 1.25 and 1.75 inches. The glass fibers may all have about the same target length, such as 0.75 inches, 1.0 inch, 1.25 inches, or 1.5 inches. However, fibers of different lengths and diameters can also be used to produce non-woven fiber mats with different characteristics. As described hereinbelow, in a specific embodiment, the fibers may have an average length of about 1.5 inches, which may provide additional synergistic effects when combined with the binder composition described herein. In such embodiments, the fibers may have diameters in the range of 14 to 20 microns, and in a specific embodiment, the average fiber diameter may be about 16 microns or 18 microns. The use of the longer (e.g., 1.5 inch) and greater diameter (e.g., 18 micron) fibers may result in the non-woven fiber mat being substantially more open and porous, such as the fiber mat illustrated in FIG. 4.

The non-woven fiber mats may be used for building materials, for example, as components of roofing shingles. The non-woven mats may be formed by contacting the binder compositions with a mesh of fibers (e.g., glass fibers) and curing the mixture to form the composite mat. The finished mat may contain about 50 wt. % to about 90 wt. % fibers, and about 10 wt. % to about 50 wt. % (e.g., about 15-30 wt. %) of the binder matrix (i.e., the cured binder).

The non-woven fiber mat 200 may have a basis weight of between 49 and 98 g/m². In one embodiment, the non-woven fiber mat 200 has a basis weight of about 88 g/m², 86 g/m², 83 g/m², 81 g/m², or about 78 g/m².

The non-woven fiber mat 200 that includes the binder composition described herein exhibits enhanced strength characteristics compared with mats made with conventional UF binder compositions. For example, the non-woven fiber mat 200 exhibits total tear strengths that are at least 5% greater than non-woven fiber mats made with a non-modified UF binder, such as being between about 5% to about 40% greater than non-woven fiber mats made with a non-modified UF binder. More commonly, the non-woven fiber mat 200 exhibits total tear strengths that are between about 10% to about 40% greater, or between about 20% to about 40% greater, than non-woven fiber mats made with a non-woven UF binder.

The addition of either the starch compound or the hydrophobic agent to the binder composition will result in a total tear strength that is at least 5% greater than non-woven fiber mats made with a non-modified UF binder. However, the combination of both a starch compound and a hydrophobic agent to the binder composition has a dramatic and unexpected effect on increasing the total tear strength of the non-woven fiber mat. For example, the addition of a starch compound or a hydrophobic agent alone to the binder composition may result in a tear strength improvement of around 5% to 10%. However, the combination of a starch compound and a hydrophobic agent to the binder composition may result in a tear strength improvement of at least 20% and more commonly at least 25%. Thus, the starch component and hydrophobic agent work synergistically to unexpectedly and dramatically improve the overall tear strength of the non-woven fiber mat. The improvement in tear strength is often achieved while other strength characteristics, such as a total tensile strength, remain relatively unchanged.

In some instances, the urea-formaldehyde resin binder composition includes about 0.5 wt. % to about 10 wt. % of the one or more starch compounds, and more commonly includes about 0.5 wt. % to about 5 wt. % of the one or more starch compounds. The urea-formaldehyde resin binder composition also typically includes about 0.5 wt. % to about 5 wt. % of the hydrophobic agent, and more commonly about 0.5 wt. % to about 3 wt. % of the hydrophobic agent. In specific embodiments, the urea-formaldehyde resin binder composition includes about 0.5 wt. % to about 2.0 wt. %, or between about 0.5 wt. % to about 1.5 wt. %, of the hydrophobic agent. As noted herein, the hydrophobic agent may include a polymer with one or more hydrophobic groups.

The dramatic and unexpected increase in the tear strength of the non-woven fiber mat may be further enhanced by the use of longer and thicker fibers in the non-woven fiber mat. For example, the use of fibers having an average length of about 1.5 inches, or at least 1.5 inches, and an average fiber diameter of about 18 microns, or at least 18 microns, with the binder composition that includes the starch compound and hydrophobic agent may result in a tear strength improvement of at least 30% and more commonly at least 35% in comparison with a non-woven fiber mats made with a non-modified UF binder. In some instances, the tear strength improvement may be around 40%, or even 45%, with the use of the longer and thicker fibers in the non-woven fiber mat. This dramatic improvement is unexpected and surprising, especially since the inclusion of the longer and thicker fibers may not have a significant effect on the total tensile strength of the non-woven fiber mat.

The dramatic increase in tear strength that is achieved via the combination of the starch compound and hydrophobic agent may enable lower basis weight non-woven fiber mats to be used in a given application, such as in asphalt shingles, while a required tear strength is achieved or even exceeded. For example, a basis weight below 88 g/m² (e.g., 86 g/m², 83 g/m², 81 g/m², or about 78 g/m²) may be employed with the mat tear strength is maintained or even improved. The use of the longer and thicker fibers may further enable lower basis weight non-woven fiber mats to be used since the improvement in tear strength is even more dramatic with the inclusion of the longer and thicker fibers. Thus, basis weights between 78 g/m² and 83 g/m² may be used for a given application.

While not wishing to be bound by any particular scientific theory, it is believed that starch and UF resin crosslink with each other via reaction between hydroxyl functionalities on starch molecules and reactive functionalities on UF resin, and this crosslinking strengthens non-woven fiber mats. Additionally, the hydrophobic groups of the hydrophobic agent associate with the hydrophobic regions of starch and form physical crosslinking of the fibers, thereby dramatically improving the tear strength of the non-woven fiber mat. The hydrophobic region of a starch molecule refers to the inner part of the amylose helix, which is formed by a long chain of glucose units linked together. The inner cavity of the amylose helix is hydrophobic, and this hydrophobic region can interact with hydrophobic groups in the hydrophobic agent of this invention.

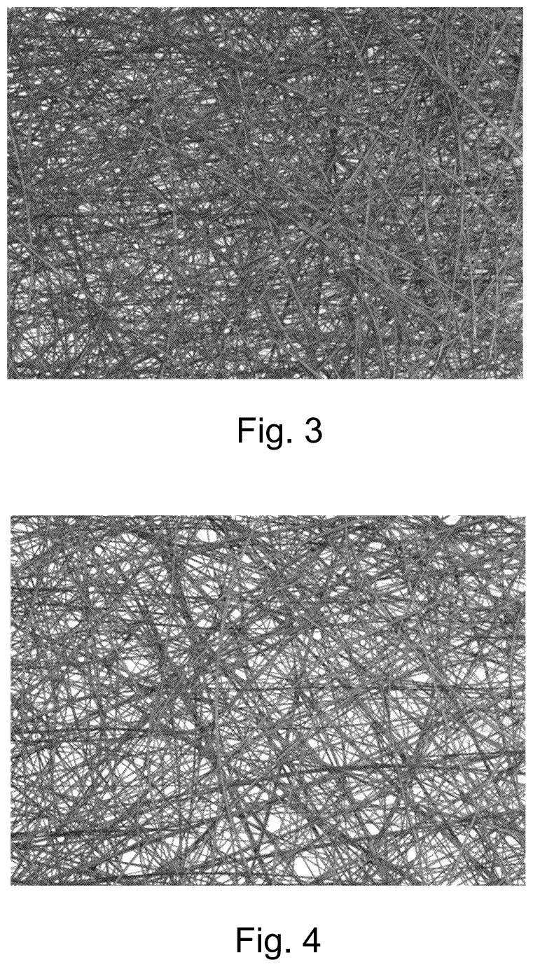

The use of coarser fibers allows the non-woven fiber mat 200 to be more open or porous in comparison with conventional non-woven fiber mats. For example, FIG. 3 illustrates a non-woven fiber mat that is composed of glass fibers with an average length of about 1.25 inches and an average diameter of 16 μm. The non-woven fiber mat of FIG. 3 has an areal weight of roughly 81 g/m² and a fiber content of roughly 80 wt. %. FIG. 4 illustrates a non-woven fiber mat that includes glass fibers with an average length of about 1.50 inches and an average diameter of 18 μm. Similar to the non-woven fiber mat of FIG. 3, the non-woven fiber mat of FIG. 4 has an areal weight of roughly 81 g/m² and a fiber content of roughly 80 wt. %. The non-woven fiber mats of FIGS. 3 and 4 each included a binder composition having a starch compound and hydrophobic agent (see Experimental section below) as described herein. The basis weight of the non-woven fiber mats of FIGS. 3 and 4 was also the same. In comparison with the non-woven fiber mat of FIG. 3, the non-woven fiber mat of FIG. 4 is substantially more open and porous due to the inclusion of the longer and thicker fibers. The longer and thicker fibers enable fewer fibers to be used while the basis weight of the composite is maintained.

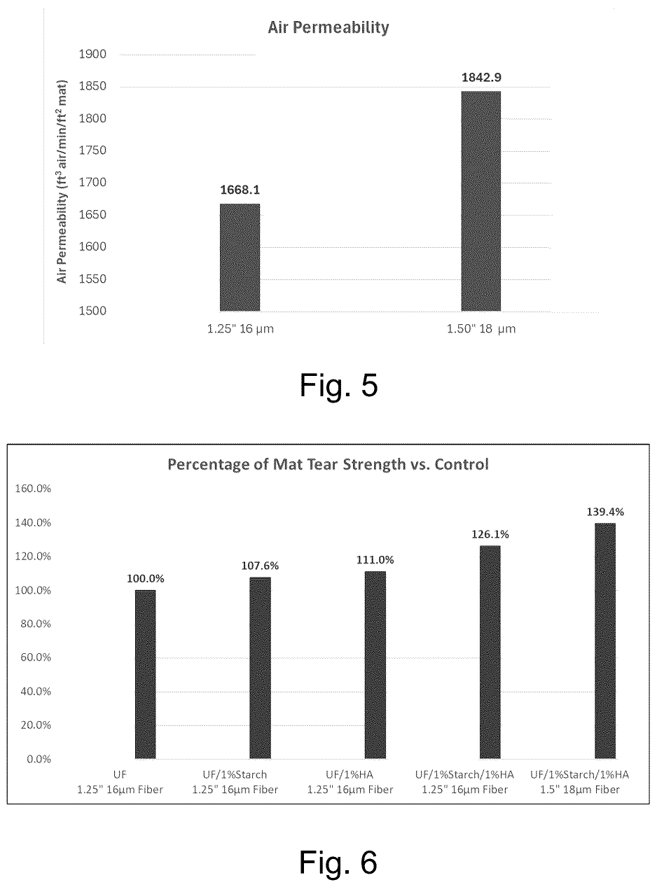

As a result of fewer fibers in the non-woven fiber mat of FIG. 4, significantly higher air permeability is achieved, as compared with the non-woven fiber mat of FIG. 3. FIG. 5. shows the air permeabilities of the non-woven fiber mats of FIG. 3 and FIG. 4 respectively. Air permeability of non-woven fiber mats is measured on a Frazier Permeometer from Frazier Precision Instrument Company. The fewer fibers in the non-woven fiber mat of FIG. 4 resulted in an air permeability increase of greater than 10%. The more open and porous non-woven fiber mat of FIG. 4 may enhance the properties of the non-woven fiber mat 200 in a given application. For example, in asphalt shingle applications, the more open and porous construction of the non-woven fiber mat of FIG. 4 may enable improved asphalt penetration through the reinforcing mat and result in higher shingle performance such as increased shingle tear strength. The increased tear strength of the non-woven fiber mat 200 results in the roofing shingle being less prone to damage and wear.

### EXPERIMENTAL

As noted above, the non-woven fiber mats made from the present binder compositions show improved tear strengths as compared to corresponding binder compositions without starch and hydrophobic agent. Table 1 shows the results of tear and tensile tests for non-woven fiber glass mat samples bonded with various UF resins. The UF resins evaluated included (1) a FG-705C UF resin from Hexion (control resin), (2) a FG-705C UF resin modified with 1.0 wt. % Rheotech® 2800 from Arkema, which is used as a hydrophobic agent (HA), (3) a FG-705C UF resin modified with 1.0 wt. % CATOR 232 starch from Ingredion, and (4) a FG-705C UF resin modified with 1.0 wt. % CATOR 232 starch and 1.0 wt. % Rheotech® 2800 hydrophobic agent. Each mat in rows 1-4 included glass fibers having an average length of 1.25 inches and an average fiber diameter of 16 microns. The basis weight of each mat was also the same so that only the addition of the hydrophobic agent and/or starch was varied among the four samples.

Tear samples (2.5″×3″) and tensile samples (1″×6″) were cut along machine direction (MD) and cross machine direction (CMD) of glass mats, which have a basis weight of 88 g/m² and a binder content of 20 wt. %. Tear strengths for fiber glass mat samples were measured on an Elmendorf tear tester, and tensile strengths for fiber glass mat samples were measured using a Instron tensile tester.

TABLE 1
Physical Properties of Glass Mats Made with Modified UF Resins

| | | Tear | Tear | Total | Tensile | Tensile | Total |
|---|---|---|---|---|---|---|---|
| | | MD | CMD | Tear | MD | CMD | Tensile |
| Binder | Fiber | (grams) | (grams) | (grams) | (lbf) | (lbf) | (lbf) |
| UF (Control) | 1.25″ 16 μm Fiber | 525.1 | 458.8 | 983.9 | 35.1 | 40.0 | 75.1 |
| UF/1% HA | 1.25″ 16 μm Fiber | 546.1 | 546.2 | 1092.3 | 31.8 | 35.4 | 67.2 |
| UF/1% Starch | 1.25″ 16 μm Fiber | 566.9 | 491.6 | 1058.5 | 38.8 | 47.1 | 85.9 |
| UF/1% HA/1% Starch | 1.25″ 16 μm Fiber | 595.3 | 645.0 | 1240.3 | 35.1 | 34.8 | 69.9 |
| UF/1% HA/1% Starch | 1.50″ 18 μm Fiber | 690.5 | 681.4 | 1371.9 | 30.2 | 34.0 | 64.2 |

FIG. 6 illustrates the percentage improvement in mat tear strength of the non-woven fiber glass mats in Table 1 in comparison with the control sample.

As illustrated, the control (i.e., UF binder only) had a total tear strength of approximately 984 grams. The addition of a 1.0 wt. % of the starch to the UF binder resulted in a tear strength of approximately 1059 grams, which represents an increase in tear strength of roughly 107.6% in comparison with the control. The addition of 1.0 wt. % of a hydrophobic agent to the UF binder resulted in a tear strength of approximately 1092 grams, which represents an increase in tear strength of roughly 111.0% in comparison with the control. Surprisingly, the addition of both a 1.0 wt. % starch and 1.0 wt. % hydrophobic agent to the UF binder resulted in a dramatic and substantial improvement in the tear strength of the non-woven fiber glass mat. Specifically, the addition of both 1.0 wt. % starch and 1.0 wt. % hydrophobic agent resulted in a tear strength of approximately 1240 grams, which represents an increase in tear strength of roughly 126% in comparison with the control. While some improvement may have been expected, the dramatic increase in tear strength represents an unexpected result. The results are more surprising given that the addition of the starch and/or hydrophobic agent did not have a significant difference, or had negligible impact, on the total tensile strength of the non-woven fiber glass mat. Specifically, the total tensile strength of the non-woven fiber glass mat remained essentially the same with a slight discernible increase in strength with the addition of 1.0 wt. % starch alone and a slight discernible decrease in strength with the addition of 1.0 wt. % hydrophobic agent or the combination of the starch and hydrophobic agent. In summary, the addition of both the starch compound and hydrophobic agent did not materially change the total tensile strength of the non-woven fiber glass mat, but had a surprising and unexpected dramatic increase in the tear strength of the non-woven fiber glass mat.

Table 1 and FIG. 6 also provide data on another modification of the non-woven fiber glass mat. Specifically, in row 5 of Table 1, a non-woven fiber glass mat was prepared using a binder composition that included the FG-705C UF resin modified with 1.0 wt. % CATO® 232 starch and 1.0 wt. % Rheotech® 2800 and that also include glass fibers have an average length of about 1.5 inches and an average diameter of about 18 microns. Thus, the non-woven fiber glass mat in row 5 differs from the non-woven fiber glass mat in row 4 only in that longer fibers with a greater diameter were used. The basis weight was kept constant between the non-woven fiber glass mat and the tested sample. The inclusion of the longer and thicker fibers resulted in a tear strength of approximately 1372 grams, which represents an increase in tear strength of roughly 139% in comparison with the control. This dramatic increase in tear strength due to the inclusion of longer and thicker fibers was a surprising and unexpected result, especially given that the inclusion of the longer and thicker glass fibers had a negligible impact, or possible slight decrease, on the total tensile strength of the non-woven fiber glass mat. Thus, in some instances, to achieve the greatest tear strength of a non-woven fiber glass mat, it may be beneficial to use a binder composition that includes both a starch compound and a hydrophobic agent as described herein and that further includes glass fibers having an average fiber length of at least about 1.5 inches and an average fiber diameter of at least about 18 microns.

Regarding the urea-formaldehyde resin, UF resins are formed by chemically combining urea, which is a solid crystal obtained from ammonia, and formaldehyde, which is typically a highly reactive gas that is obtained from methane. Urea-formaldehyde (UF) resins are commonly synthesized or formed via condensation polymerization from an aqueous solution of formaldehyde and urea. Ammonia may be used as an alkaline catalyst or the reaction may occur under relatively neutral conditions. The condensation polymerization reaction results in a viscous UF resin that can be applied as an adhesive for various applications. A common application involving UF resin is coating non-woven fiber mats, which are commonly made of glass fibers or other organic or inorganic fibers. In regards to non-woven fiber mats, the UF resin is typically coated atop a web or mesh of loose fibers. The coated fiber mat is then passed through an oven where heat is used to cure the UF resin to form the non-woven fiber mat. Prior to curing, the UF resin is composed mainly of low-molecular-weight intermediate polymers or prepolymers, whereas curing results in the formation of a network of crosslinked polymers.

As described herein, a starch modifier may be combined with the UF resin to modify the UF resin. The starch modifier may include one or more starch compounds as described herein. The modified UF resin may be particularly useful for applications that involve non-woven mats as described herein. Several methods of forming a modified UF composition are described herein. For example, in some embodiments the starch may be added prior to or during the synthesis of UF resin. In such embodiments, chemical reactions may occur between starch and UF resin. The chemical reaction between starch and UF resin may increase homogeneity of the modified UF resin. In other embodiments, the starch may be added to the UF resin at the later stages of synthesis, or even after synthesis, of the UF resin.

The modified UF resin may promote toughening and/or strengthening of a product made from the thermoset UF binder. Exemplary starch concentration ranges in the modified UF resin may be from about 1 wt. % to about 10 wt. % of the binder composition. Additional exemplary starch concentration ranges may include about 1 wt. % to about 7.5 wt. %; about 1 wt. % to about 5 wt. %; 1 wt. % to about 4 wt. %; about 1 wt. % to about 3 wt. %; about 1 wt. % to about 2.5 wt. %; about 1 wt. % to about 2 wt. %; about 1 wt. % to about 1.5 wt. %, etc. In a specific embodiment, the starch concentration may be less than 5 wt. %, such as about 1 wt. %.

One method of forming a modified UF resin involves dissolving one or more starch compounds in water to form a starch solution. The starch solution may then be combined with formaldehyde and urea prior to or during the synthesis of UF resin. Alternatively, the starch solution may be added to the synthesized UF resin. For example, in one embodiment the condensation polymerization process may be initiated and then the starch solution may be added to the aqueous solution of formaldehyde and urea. In another embodiment, the formaldehyde and urea may be added to the starch solution so that the water in the starch solution functions as the aqueous environment for the formaldehyde and urea. The aqueous solution of starch, formaldehyde, and urea may then be reacted to form the modified UF resin. The starch solution may be blended in the UF resin in a specific ratio. The introduction of the starch solution prior to or during UF resin synthesis may result in a greater degree of bonding of the starch and UF resin.

In some instances, starch granules may be added to the aqueous solution of formaldehyde and urea prior to heating the solution to form or synthesize the UF resin. In such instances, the starch granules dissolve within the aqueous solution of formaldehyde and urea as the mixture is heated.

Another method of forming a modified UF resin involves adding a starch slurry to the heated aqueous solution of formaldehyde and urea prior to or during the synthesis of the UF resin. Different from a starch solution, which typically has high viscosity, starch slurry has relatively low viscosity. Therefore, a starch slurry can be easily mixed with the aqueous solution of formaldehyde and urea without significant increase in viscosity. The elevated temperature that is needed for the synthesis of UF resin helps the dissolution of starch granules in water during the synthesis of UF resin.

Another method of forming a modified UF resin involves adding a starch slurry to the heated UF resin at the completion of the UF resin synthesis process, before the UF resin is cooled down. The starch granules in the slurry may be dissolved in the heated UF resin and the mixture may be cooled to room temperature after the starch dissolves.

Regardless of the method that is employed, the modified UF resin may be applied to a material to provide one or more desired characteristics. For example, the modified UF resin may be added to a non-woven fiber mat to toughen and/or strengthen the non-woven fiber mat. The modified UF resin may be applied to the non-woven fiber mat in various amounts including any amount described herein. The modified UF resin may then be cured to form crosslinked polymers and thereby bond the fibrous material together, such as bonding the fibers of the non-woven fiber mat together.

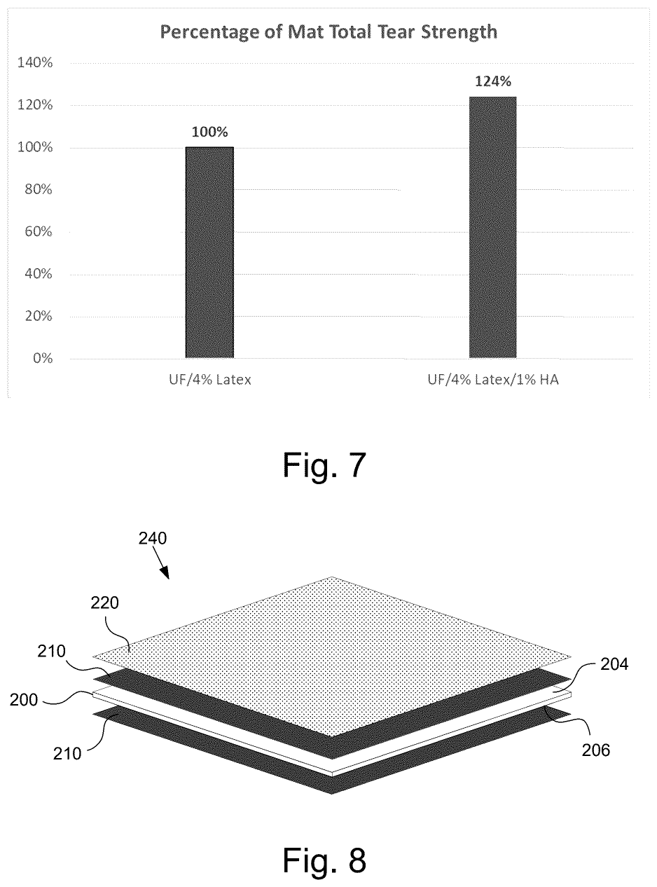

When a UF binder is modified with a conventional acrylic latex, the addition of a hydrophobic agent still results in significant improvement in total mat tear strength, as shown in FIG. 7. For example, when 1 wt. % hydrophobic agent Rheovis® HS 1332 (from BASF) is added to a modified UF resin that contains 4 wt. % GL-720 acrylic latex (from Dow Chemical), a 24% increase in mat tear strength is achieved.

When the UF binder is modified with latex modifier, the binder composition, or modified urea-formaldehyde resin, may include a urea-formaldehyde resin, one or more latex modifiers combined with the urea-formaldehyde resin, and a hydrophobic agent that is combined with the urea-formaldehyde resin and one or more latex modifiers to form the modified urea-formaldehyde resin. In such instances, the one or more latex modifiers may be combined with the urea-formaldehyde resin so that the modified urea-formaldehyde resin includes about 0.5 wt. % to about 10 wt. % of the one or more latex modifiers, between about 0.5 wt. % to about 5 wt. % of the one or more latex modifiers, or between about 1 wt. % to about 2 wt. % of the one or more latex modifiers. The hydrophobic agent may be combined with the urea-formaldehyde resin and one or more latex modifiers so that the modified urea-formaldehyde resin includes about 0.5 wt. % to about 5 wt. % of the hydrophobic agent, between about 0.5 wt. % to about 3 wt. % of the hydrophobic agent, or between about 1.0 wt. % to about 2.0 wt. %.

The hydrophobic agent may include or consist of a polymer and a hydrophobic group. As with the binder composition that includes one or more starch compounds, the synthesized urea-formaldehyde resin may be composed mainly of low-molecular-weight intermediate polymers or prepolymers. The binder composition may have a solids content of about 5 to 35 wt. % or a solids content of greater than 35 wt. %. The one or more latex modifiers may be polyvinyl acetate, polyethylene vinyl acetate, polyacrylate, acrylic, vinyl acrylic, styrene-butadiene latexes, or a combination thereof.

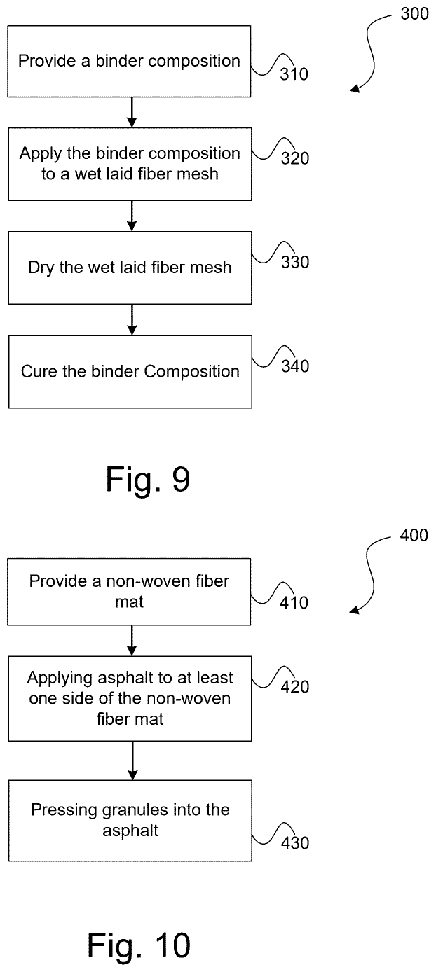

Referring to FIG. 9, a method 300 of forming a non-woven fiber mat is illustrated. At box 310, a binder composition is provided. As described herein, the binder composition includes a urea-formaldehyde resin, about 0.5 wt. % to 5 wt. % of a hydrophobic agent, and about 1 wt. % to about 10 wt. % of a starch. At block 320, the binder composition is applied to a wet laid fiber mesh. At block 330, the wet laid fiber mesh is dried. At block 340, the binder composition is cured to bond fibers of the fiber mesh and thereby form the non-woven fiber mat.

The plurality of fibers may have an average fiber diameter of between 15 to 20 microns and/or an average fiber length of between 0.5 and 2.0 inches. The non-woven fiber mat may have a basis weight of between 49 g/m² and 98 g/m², and more commonly a basis weight of between 78 g/m² and 83 g/m². The fibers of the fiber mesh may include or consist of glass fibers. The modified urea-formaldehyde resin may include about 0.5 wt. % to about 3 wt. % of the hydrophobic agent and/or about 0.5 wt. % to about 5 wt. % of the one or more starch compounds. The hydrophobic agent may include or consist of a polymer and a hydrophobic group.

Referring to FIG. 8, illustrated is a composite asphalt roofing shingle 240 (hereinafter shingle 240). The shingle 240 is designed for durability, weather resistance, and aesthetic appeal. The shingle 240 includes a non-woven fiber mat 200 having a composition as described herein. For example, the non-woven fiber mat 200 includes a plurality of fibers that form a fiber mesh and a modified urea-formaldehyde resin that bonds or adheres the plurality of fibers together. The modified urea-formaldehyde resin includes or consists of a urea-formaldehyde resin, one or more starch compounds combined with the urea-formaldehyde resin, and a hydrophobic agent. The modified urea-formaldehyde resin typically includes about 0.5 wt. % to about 10 wt. % of the one or more starch compounds and about 0.5 wt. % to about 5 wt. % of the hydrophobic agent. In some embodiments, the modified urea-formaldehyde resin includes about 0.5 wt. % to about 3 wt. % of the hydrophobic agent and/or about 0.5 wt. % to about 5 wt. % of the one or more starch compounds. The hydrophobic agent may include or consist of a polymer and a hydrophobic group. The non-woven fiber mat 200 reinforces the shingle 240 and provides structural integrity.

The shingle 240 also includes asphalt 210 that is applied to at least one side of the non-woven fiber mat 200 so that the non-woven fiber mat 200 is saturated with the asphalt 210. Specifically, the non-woven fiber mat 200 is coated with the asphalt 210, which is typically a petroleum-based binder that waterproofs the shingle and binds its components. The asphalt 210 is typically coated so that it is positioned on both the top surface 204 and the bottom surface 206 of the non-woven fiber mat 200. The asphalt 210 may be an oxidized asphalt or a modified asphalt. Oxidized asphalt is commonly stiffer and more resistant to temperature fluctuations than modified asphalt, which may make it suitable for traditional shingles. Modified asphalt, which is commonly blended with polymers like styrene-butadiene-styrene (SBS) or atactic polypropylene (APP), commonly exhibits enhanced flexibility and elasticity in comparison with oxidized asphalt, which may improve performance in extreme weather and/or extend a lifespan of the shingle 240.

The shingle further includes granules 220 that are positioned on an upper or exterior surface of the composite asphalt roofing shingle and pressed into the asphalt 210 to attach the granules 220 to the shingle 240. The granules 220 are included on the top surface of the shingle 240 and are typically embedded within the asphalt 210. The granules 220 protect the asphalt 210 from UV radiation and/or may provide fire resistance. The granules 220 also contribute to the shingle's color and texture. Granules 220 are typically made from crushed rock or slag and may be coated with ceramic to lock in color and enhance durability. In some instances, the shingle 240 may incorporate reflective granules to reduce heat absorption and/or improve energy efficiency.

In some instances, the fibers of the non-woven fiber mat 200 have an average fiber diameter of between 15 to 20 microns and/or an average fiber length of between 0.5 and 2.0 inches. The non-woven fiber mat may have a basis weight of between 49 g/m² and 98 g/m², and more commonly a basis weight of between 78 g/m² and 83 g/m².

Referring to FIG. 10, illustrated is a method 400 of forming a roofing shingle. At block 410, a non-woven fiber mat is provided. The non-woven fiber mat includes a plurality of fibers that form a fiber mesh and a modified urea-formaldehyde resin that is applied to the fiber mesh to bond or adhere the plurality of fibers together. The modified urea-formaldehyde resin includes a urea-formaldehyde resin, about 1.0 wt. % to about 10 wt. % of a starch, and about 0.5 wt. % to 5 wt. % of a hydrophobic agent. At block 420, asphalt is applied to at least one side of the non-woven fiber mat so that the non-woven fiber mat is saturated with the asphalt. At block 430, granules are applied and pressed into the asphalt to attach the granules to the shingle. When pressed into the asphalt, the granules are positioned on an upper or exterior surface of the roofing shingle.

The asphalt may be an oxidized asphalt or a modified asphalt. The fibers of the non-woven fiber mat may have an average fiber diameter of between 15 to 20 microns and/or an average fiber length of between 0.5 and 2.0 inches. The non-woven fiber mat may have a basis weight of between 49 g/m² and 98 g/m², and more commonly a basis weight of between 78 g/m² and 83 g/m². In some instances, the fibers of the fiber mesh consist of glass fibers. The modified urea-formaldehyde resin may include about 0.5 wt. % to about 3 wt. % of the hydrophobic agent and/or about 0.5 wt. % to about 5 wt. % of the one or more starch compounds. The hydrophobic agent may include or consist of a polymer and a hydrophobic group.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the starch” includes reference to one or more starches and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

1. A binder composition comprising:
a modified urea-formaldehyde resin including:
a urea-formaldehyde resin;
one or more starch compounds combined with the urea-formaldehyde resin;
a hydrophobic agent combined with the urea-formaldehyde resin and one or more starch compounds to form the modified urea-formaldehyde resin;
wherein the one or more starch compounds are combined with the urea-formaldehyde resin so that the modified urea-formaldehyde resin includes about 0.5 wt. % to about 10 wt. % of the one or more starch compounds; and
wherein the hydrophobic agent is combined with the urea-formaldehyde resin and one or more starch compounds so that the modified urea-formaldehyde resin includes about 0.5 wt. % to about 5 wt. % of the hydrophobic agent.

2. The binder composition of claim 1, wherein the modified urea-formaldehyde resin includes about 0.5 wt. % to about 3 wt. % of the hydrophobic agent.

3. The binder composition of claim 2, wherein the modified urea-formaldehyde resin includes about 0.5 wt. % to about 5 wt. % of the one or more starch compounds.

4. The binder composition of claim 1, wherein the hydrophobic agent comprises a polymer and a hydrophobic group.

5. The binder composition of claim 1, wherein the urea-formaldehyde resin is synthesized via condensation polymerization of an aqueous solution of starch, formaldehyde, and urea, in which water in a starch slurry provides an aqueous environment for formaldehyde and urea.

6. The binder composition of claim 1, wherein:
the urea-formaldehyde resin is synthesized from an aqueous solution of formaldehyde and urea; and
a starch slurry is added to the aqueous solution of formaldehyde and urea during synthesis of the urea-formaldehyde resin to combine the one or more starch compounds with the urea-formaldehyde resin.

7. The binder composition of claim 1, wherein:
the urea-formaldehyde resin is synthesized by heating an aqueous solution of formaldehyde and urea to at or near a boiling temperature of the aqueous solution of formaldehyde and urea; and
a starch slurry is combined with the heated aqueous solution of formaldehyde and urea solution and cooled to an ambient temperature.

8. The binder composition of claim 1, wherein:
the urea-formaldehyde resin is composed mainly of low-molecular-weight intermediate polymers or prepolymers.

9. The binder composition of claim 1, wherein the binder composition has a solids content of about 5 to 35 wt. %.

10. The binder composition of claim 1, wherein the binder composition has a solids content of greater than 35 wt. %.

11. The binder composition of claim 1, wherein:
the one or more starch compounds is selected from the group consisting of a native starch, a cationically modified starch, and an anionically modified starch;
hydroxyl functional groups on the one or more starch compounds bond to reactive functional groups on the urea-formaldehyde resin; and
the binder composition lacks a styrene-containing, petroleum-based modifier.

12. The binder composition of claim 1, wherein the binder composition comprises about 1 wt. % to about 2 wt. % of the one or more starch compounds.

13. A method of forming a binder composition comprising:
providing a urea-formaldehyde resin;
combining one or more starch compounds with the urea-formaldehyde resin; and
combining a hydrophobic agent with the urea-formaldehyde resin and one or more starch compounds to form a modified urea-formaldehyde resin; and
wherein the one or more starch compounds are combined with the urea-formaldehyde resin so that the modified urea-formaldehyde resin includes about 0.5 wt. % to about 10 wt. % of the one or more starch compounds; and
wherein the hydrophobic agent is combined with the urea-formaldehyde resin and one or more starch compounds so that the modified urea-formaldehyde resin includes about 0.5 wt. % to about 5 wt. % of the hydrophobic agent.

14. The method of claim 13, wherein the modified urea-formaldehyde resin includes about 0.5 wt. % to about 3 wt. % of the hydrophobic agent.

15. The method of claim 14, wherein the modified urea-formaldehyde resin includes about 0.5 wt. % to about 5 wt. % of the one or more starch compounds.

16. The method of claim 13, wherein the hydrophobic agent comprises a polymer and a hydrophobic group.

17. The method of claim 13, wherein the urea-formaldehyde resin is synthesized via condensation polymerization of an aqueous solution of starch, formaldehyde, and urea, in which water in a starch slurry provides an aqueous environment for formaldehyde and urea.

18. The method of claim 13, wherein:
the urea-formaldehyde resin is synthesized from an aqueous solution of formaldehyde and urea; and
a starch slurry is added to the aqueous solution of formaldehyde and urea during synthesis of the urea-formaldehyde resin to combine the one or more starch compounds with the urea-formaldehyde resin.

19. The method of claim 13, wherein:
the urea-formaldehyde resin is synthesized by heating an aqueous solution of formaldehyde and urea to at or near a boiling temperature of the aqueous solution of formaldehyde and urea; and
a starch slurry is combined with the heated aqueous solution of formaldehyde and urea solution and cooled to an ambient temperature.

20. The method of claim 13, wherein:
the urea-formaldehyde resin is composed mainly of low-molecular-weight intermediate polymers or prepolymers.

21. The method of claim 13, wherein the binder composition has a solids content of about 5 to 35 wt. %.

22. The method of claim 13, wherein the binder composition has a solids content of greater than 35 wt. %.

23. The method of claim 13, wherein:
the one or more starch compounds is selected from the group consisting of a native starch, a cationically modified starch, and an anionically modified starch;
hydroxyl functional groups on the one or more starch compounds bond to reactive functional groups on the urea-formaldehyde resin; and
the binder composition lacks a styrene-containing, petroleum-based modifier.

24. The method of claim 13, wherein the binder composition comprises about 1 wt. % to about 2 wt. % of the one or more starch compounds.

25.-70. (canceled)
